(19) United States
(12) Patent Application Publication
(10) Pub. No.: US 2026/0172421 A1
(43) Pub. Date: Jun. 18, 2026

(54) CLIENT-INITIATED DEVICE FINGERPRINT DATA COLLECTION

(71) Applicant: Microsoft Technology Licensing, LLC, Redmond, WA (US)

(72) Inventors: Megan WALSH, Seattle, WA (US); Pui Yin Winfred WONG, Redmond, WA (US); Rajesh MAHESWARAN, Santa Clara, CA (US); Arjun MALHOTRA, Sammamish, WA (US); Yelena BYKOVA, Bothell, WA (US); Jingsheng ZHOU, Bellevue, WA (US); Max Chen MORRISON, Seattle, WA (US); Navindra UMANEE, Bothell, WA (US); Rohit Rishikant SHENDE, Bellevue, WA (US); Wenjun QIU, Bothell, WA (US); Adrian FREI, Seattle, WA (US)

(21) Appl. No.: 18/982,289

(22) Filed: Dec. 16, 2024

(51) Int. Cl. H04L 9/40

(52) U.S. Cl. CPC H04L 63/0876

(57) ABSTRACT

A client on a computing device presents a login form seeking a username, a password, or other login data. At or near the same time that the login form is presented, and before the client receives a reply to the login form, the client requests collection of fingerprint data of the device. The collection request's timing provides more time to gather fingerprint data than an alternative approach where a server requests fingerprint data only after receiving the login data. In some cases, the fingerprint data collection request is asynchronous. In some, an absence of fingerprint data during authentication indicates an anomaly. In some cases, the fingerprint data collection request is made from an iframe injected into a client's user interface. In some cases, the fingerprint data is collected despite cancellation of the login sequence.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by identifying and closing security gaps, and by forcing attackers to encounter multiple different kinds of security mechanisms at multiple different locations around or within the computing system. No single security mechanism is able to identify every vulnerability or detect every kind of cyberattack, able to determine the scope of an attack or a vulnerability, able to remove every vulnerability, and able to end every detected cyberattack. But sometimes combining and layering a sufficient number and variety of defenses and investigative tools will prevent an attack, deter an attacker, or at least help limit the scope of harm from an attack or a vulnerability.

To implement defense in depth, cybersecurity professionals consider the different kinds of attacks that could be made against a computing system, and the different vulnerabilities the system may include. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place or removing a particular vulnerability to attack. They investigate the scope of an attack, and try to detect vulnerabilities before they are exploited. Some defenses or investigations might not be feasible or cost-effective for a particular computing system. However, improvements in cybersecurity remain possible, and worth pursuing.

### SUMMARY

Some embodiments address technical challenges arising in the identification of remote computing devices. One challenge is how to map devices to user accounts, e.g., to improve security risk detections, reduce fraud, track users across websites, and identify returning visitors to a website. Another challenge is how to obtain device identifications faster, so they can be acted on sooner in a computing system. Other technical challenges are also addressed herein.

Some embodiments taught herein provide or utilize device fingerprint data collection during an interactive login sequence. A computing device is structured to recognize a presentation of an interactive login form in a user interface. In response to the presentation, the computing device requests a collection of fingerprint data of the computing device, to aid identification of the device. The collection request is made before the computing device receives a reply to the interactive login form. Then the device either utilizes a result of the collection request during a user authentication operation, or submits a collected set of device fingerprint data to a device identification module, or does both.

By requesting the device fingerprint data when the login form is presented, instead of waiting until after a password or other login data are received, the computing device provides additional time to collect fingerprint data. In some scenarios the additional time permits use of the collected device fingerprint data when making an authentication decision, without causing any perceptible fingerprinting delay before the authentication decision is presented to a user. Waiting to collect device fingerprint data until after login data are received can make the login sequence perceptibly slower in some scenarios.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems, including some aspects generally suitable for enhanced systems which include or use client-initiated device fingerprint data collection (CIDFP) functionality;

FIG. 2 is a block diagram illustrating aspects of a first example family of enhanced systems which are each configured with CIDFP functionality;

FIG. 3 is a dataflow diagram of a second example family of enhanced systems which are each configured with CIDFP functionality;

FIG. 4 is a dataflow diagram of a third example family of enhanced systems which are each configured with CIDFP functionality;

FIG. 5 is a block diagram of some actions, data structures, characteristics, and other aspects of interactive login in some enhanced systems;

FIG. 6 is a dataflow diagram of a fourth example family of enhanced systems which are each configured with CIDFP functionality;

FIG. 7 is a flowchart illustrating some CIDFP methods; and

FIG. 8 is a flowchart further illustrating CIDFP methods, and incorporating as options the steps of FIG. 7 and other steps discussed herein.

### DETAILED DESCRIPTION

### Overview

Some teachings described herein were motivated by technical challenges faced and insights gained during efforts to improve attack detection by reducing false positives during logins that utilize an identity provider. These challenges and insights provided some motivations, but the teachings herein are not limited in their scope or applicability to this particular identity provider, or to these particular motivational challenges, solutions, or insights.

Device identification can increase security by helping a security subsystem match activity to a pattern of suspicious behavior. One suspicious behavior pattern includes a given device being used during attempts to log into multiple different accounts. Another suspicious behavior pattern includes a given device being used during an attempt to log in from an IP address or a geographic location that was never before encountered by the system as that given device's location when it previously logged in. Another suspicious behavior pattern includes a given device being used during an attempt to log into a highly secure network which has not previously encountered that device.

In some scenarios, one approach to device identification involves the following. A browser is opened and a URL is entered, e.g., contoso dot com. Login software presents a login page with a form that asks for a username and a password. An Enter key press or a Login button click indicates that the username and password have been placed in the form as login data. The login data is passed to a backend authentication service that assesses it and determines whether to grant the login request.

To aid that assessment, the backend service makes an outgoing call to a device fingerprinting service. The device fingerprinting service collects at least some of the available device identification data, such as browser version, screen resolution, operating system version, and other identifiers. Depending on the particular implementation, the device fingerprinting service either sends the device identification data to the authentication service, or does a lookup and sends the authentication service a list of one or more identifications of known devices that match the device identification data.

The authentication service uses the information from the device fingerprinting service to check for a match to a pattern of suspicious behavior involving the identified device(s). If a match is found, the login request is denied, or a heightened authentication procedure such as multifactor authentication is invoked. If no pattern of suspicious behavior is matched, the authentication service grants the login request, and notifies the device accordingly.

Some embodiments described herein utilize or provide a different approach to device identification, referred to here as client-initiated device fingerprint data collection (CIDFP). In a CIDFP approach, the call to the device fingerprinting service is made by the client on the device where the login form is presented, instead of being made by the backend authentication service. Collected device identification data is then sent to the authentication service from the client. Moreover, the call to the device fingerprinting service is made as soon as practical after the login form is presented, or even slightly before presenting the login form, instead of being made later after the login data is received at the backend authentication service.

Each of these differences between CIDFP and the first approach provides a CIDFP-structured system with additional time to collect device fingerprinting data before the authentication service either allows or denies the login request. One piece of the additional time is the time between presentation of the login form and receipt of the login data. In situations where the login data is typed in, the size of this piece depends on typing speed and login data length (e.g., username length, password length), but it will very often be a hundred milliseconds or more. Indeed, 400 milliseconds is not an unusual amount of elapsed time to type a password. Another piece of the additional time is the time for transmission of the login data from the client over a network to the backend authentication service. This piece varies depending on factors such as distance, network infrastructure, congestion, signal propagation media used, and the processing time by network devices such as routers and switches, but it will often be at least 50 milliseconds. Thus, the CIDFP approach will often provide at least 150 milliseconds of additional time to collect device fingerprinting data compared to the first approach, and 200 milliseconds of additional fingerprint collection time will often be provided in a CIDFP-equipped system.

In some scenarios, the authentication service has a deadline (maximum elapsed time) to allow or deny the login request, using only whatever data can be obtained and processed by that deadline. In these scenarios, the additional time provided by the CIDFP approach makes it more likely that the authentication service will have the fingerprinting data in time to use it in the authentication calculations, thereby making the system better at spotting suspicious patterns of behavior.

In some other scenarios, the authentication service does not have a deadline, but instead waits for the fingerprinting data to arrive and always or nearly always uses the fingerprinting data in the authentication calculations. In those scenarios, the additional time provided by the CIDFP approach reduces the delay between submission of the login data and presentation of the login decision, thereby improving the system's performance. When that delay exceeds about 200 milliseconds, it is perceptible to many users, so reducing the delay by 150 milliseconds or more can improve user satisfaction with the system's performance (or at least reduce user dissatisfaction).

Some embodiments described herein utilize or provide a method for device fingerprint data collection during an interactive login sequence. The method is performed by a computing device, and includes: recognizing a presentation event in the computing device, the presentation event representing a presentation of an interactive login offering in a user interface; in response to the recognizing, requesting a collection of device fingerprint data of the computing device, the requesting completed prior to a receipt via the user interface of a reply to the interactive login offering; and utilizing at least a result of the requesting during a user authentication operation, or submitting a collected set of device fingerprint data which is not empty to a device identification module, or both.

This CIDFP functionality has a technical benefit of improving security by making device fingerprint data available sooner in scenarios that impose a deadline on reaching an authentication status decision (e.g., a status of login granted, login denied, or additional credential required). By providing additional time to collect the device fingerprint data before the authentication deadline, the CIDFP functionality makes the device fingerprint data available to authentication calculations in some situations where it would not yet have been available by the deadline without the additional time. Making the device fingerprint data available to authentication calculations improves security by allowing those calculations to check for suspicious patterns involving a device that was identified on the basis of the device fingerprint data.

This CIDFP functionality also has a technical benefit of improving the speed of authentication in scenarios that include device fingerprint data collection as part of authentication calculations, or ancillary to authentication calculations. The device fingerprint data collection starts sooner, and therefore tends to finish sooner, than it would without the CIDFP functionality.

This CIDFP functionality also has a technical benefit of improving the scalability of authentication calculations, by distributing device fingerprint data collection calls among clients instead of making all such calls from the centralized authentication server. Telemetry on calls to one commercial identity provider server showed a rate of approximately 25000 requests per second, of which about 4000 requests per second occurred in interactive login scenarios. This CIDFP functionality will not necessarily reduce that rate. But it will reduce a related part of the server load, by distributing at least some of the corresponding device fingerprint data collection calls to clients instead of leaving them in place as part of the server's load.

In some embodiments described herein, requesting the collection of device fingerprint data includes calling a device fingerprint data collection service from within an iframe on the computing device. This CIDFP functionality has a technical benefit of improving scalability by distributing device fingerprint collection calls to clients, and by doing so in a standardized way through an HTML element <iframe>. Compliance with an industry standard is often technically advantageous, e.g., by providing compatibility, reliability, and quality control. The <iframe> element is defined within HTML specifications, including among others the HTML5 specification Working Draft released 22 Jan. 2008 and the HTML Living Standard as of 15 Nov. 2024. These HTML standards are cited here for their existence as standards, not as embodiment requirements. There is no intention of incorporating any HTML specification document into the present description.

In some embodiments described herein, requesting the collection of device fingerprint data includes asynchronously calling a device fingerprint data collection service from the computing device. This CIDFP functionality has a technical benefit of improving performance by performing some of the device fingerprint data collection in parallel with login data gathering, instead of gathering login data and collecting fingerprint data serially. This CIDFP functionality has a technical benefit of allowing authentication calculations to proceed in some cases without waiting for device fingerprint data, which helps keep authentication fast from a user perspective.

In some embodiments described herein, the reply to the interactive login offering represents an absence of any user account identification after a login sequence escape, and the method includes submitting the collected set of device fingerprint data to the user authentication module in the absence of any user account identification.

This CIDFP functionality has a technical benefit of collecting fingerprints for devices that are testing usernames to see if they exist. A pattern of login attempts with more than usual (per historic data) non-existent usernames is suspicious, and suggests an attacker is probing the system. Even when a sign in doesn't complete or is canceled (examples of “login sequence escape”), some embodiments improve security by recording the fingerprint of the device that attempted to sign in, and by utilizing that record to manage risks. This record provides the embodiment with a list of fingerprints of devices that are suspicious for attempting logins but not finishing them, which allows the embodiment to block a suspect device from signing in, or to mark sign ins from that device as posing an increased risk.

In some embodiments, the interactive login offering includes a login form which upon presentation requests at least a username. This CIDFP functionality has a technical benefit of improving performance by gathering the username and collecting the device fingerprint data at least partially in parallel instead of serially.

In some embodiments, the interactive login offering includes a login form which upon presentation requests at least one of: a password, a biometric credential, a selection from a set of multiple active sessions, a digital certificate, or a hardware security key. This CIDFP functionality has a technical benefit of improving performance by gathering various kinds of login data and by collecting the device fingerprint data at least partially in parallel instead of serially.

In some embodiments, the result of requesting device fingerprint data represents an absence of collected device fingerprint data, and the computing system is configured to employ the absence of collected device fingerprint data as a signal during user authentication. This CIDFP functionality has a technical benefit of improving security, by using the absence of collected device fingerprint data as a signal (e.g., a factor, a consideration, a flag, or a weight) during user authentication. In particular, during internal testing of a prototype a man-in-the-middle (MITM) attack did not generate a device fingerprint, as a consequence of the MITM client not running device fingerprint data collection code. By contrast, under an approach that makes device fingerprint collection calls from the server, not from the client under CIDFP, an MITM attack would still lead to execution of device fingerprint data collection code.

In some embodiments, during an execution of device identification steps by the computing system, an advance processing time period starts when the computing system requests the collection of device fingerprint data and ends upon the receipt via the user interface of the reply to the interactive login offering, and the advance processing time period is at least two hundred milliseconds. This CIDFP functionality has technical benefits of improving security by making device fingerprint data available in more scenarios where authentication has a deadline, improving the speed of authentication, and improving the perceived usability of the system because a delay of two hundred milliseconds or more is perceptible to many users.

These and other advantages and benefits will be apparent to one of skill from the teachings provided herein.

### Operating Environments

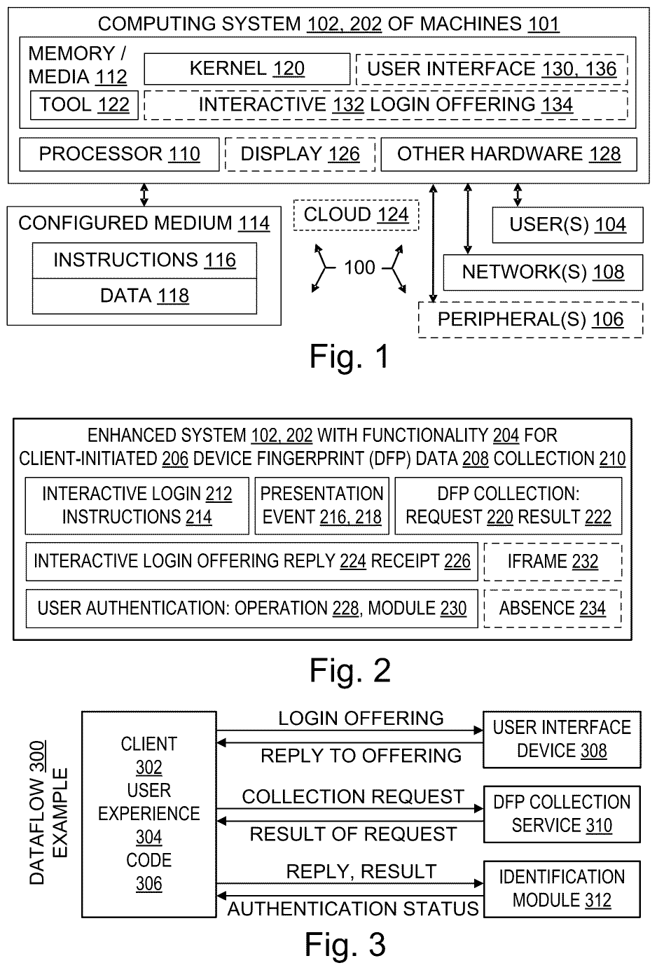

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Although for convenience, examples and claims herein sometimes speak in terms of accounts, “account” means “account or session or both” unless stated otherwise. In this disclosure, including in the claims and elsewhere, a statement about activity by “the user account or the user session” does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment 106 in some embodiments and part of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth.

Although an embodiment may include software instructions executed by one or more processors in a computing device (e.g., general purpose computer, server, or cluster), such description is not meant to exhaust all possible embodiments. Embodiments do not necessarily include any software. One of skill will also understand that the same or similar functionality of software can also often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments or operating environments, a system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected or only intermittently connected to another networked device or remote cloud. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment or another environment containing an electrical system, which are disclosed herein but not associated with a particular reference numeral herein. Corresponding drawings may also be added.

### More About Systems

FIG. 2 illustrates a computing system 102 or other system configured by one or more of the CIDFP functionality enhancements taught herein, resulting in an enhanced system 202. Not every device in an enhanced system 202 is a computing system 102; some devices lack a memory 112, lack a processor 110, or lack both memory 112 and processor 110. In some embodiments, an enhanced system 202 includes a single machine (computational or not), a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with CIDFP functionality 204. FIG. 3 items are discussed at various points in this disclosure. Unless stated otherwise, the client 302 is on, or is, a device 101 located remote (i.e., at least ten meters) away from the device fingerprint collection service 310, whereas the client 302 is, or is on, the same device 101, 308 as the user interface 130. When operating as part of a system 202, an identification module 312, or an authentication module 230, or both, are located on the device 308 or remote from the device 308, depending on the particular embodiment. Machines 101 (e.g., client 308 and server 310) which are remote from one another are connected through at least one network 108.

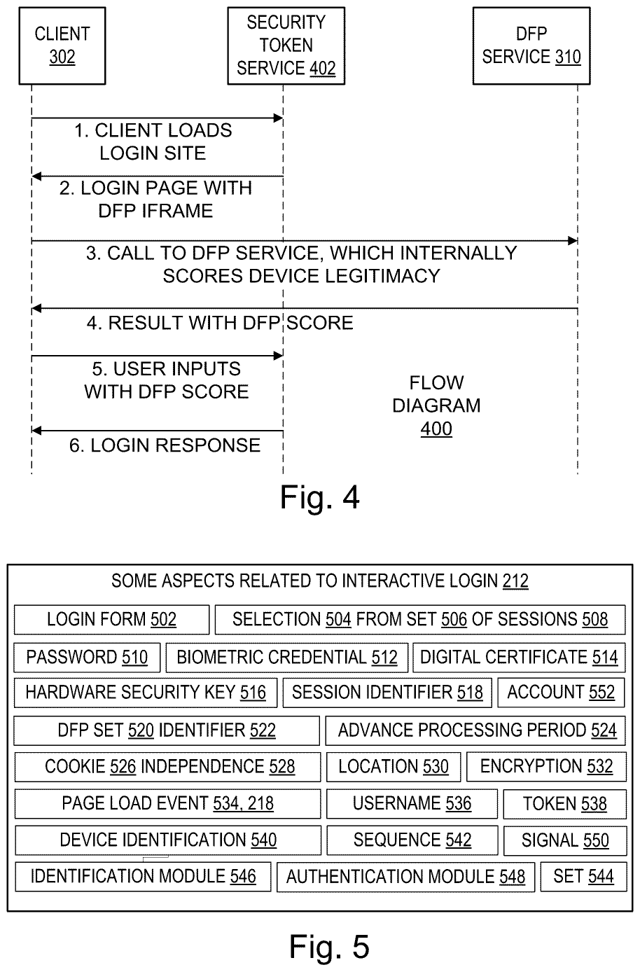

FIG. 4 is a dataflow diagram 400 of another example family of enhanced systems 202 which are each configured with CIDFP functionality 204. FIG. 4 items are discussed at various points in this disclosure.

In one example according to FIG. 4, a security token service 402 is a service such as an extended security token service, e.g., an extended protection for authentication service or an extended security update service, or another service that is authorized to issue, validate, cancel, renew, or transform security tokens 538.

In one example, in FIG. 4 step 1 a client loads a login site such as login dot contosoonline dot com. In step 3 the client makes a non-blocking AJAX call to a DFP service 310 for fingerprinting data and an AJAX verdict (e.g., a score or a Boolean value or category value) on the device's legitimacy, e.g., the device's familiarity to the system. The DFP service 310 internally calls an assessment API for the verdict. In step 4 a DFP service 310 token is captured at the client as an encrypted token 538. In step 5 the client digitally staples (e.g., bundles, associates, or links) the DFP service 310 token with the user inputs 224 from the populated login form and posts them to the security token service. The login decision is received at the client per step 6. The client 302, security token service 402, DFP service 310, or portions thereof, are configured in some embodiments to operate individually or in combination as an identification module 312 or an authentication module 230.

FIG. 5 is a block diagram of some actions, data structures, characteristics, and other aspects of interactive login 212 in some enhanced systems. FIG. 5 items are discussed at various points in this disclosure.

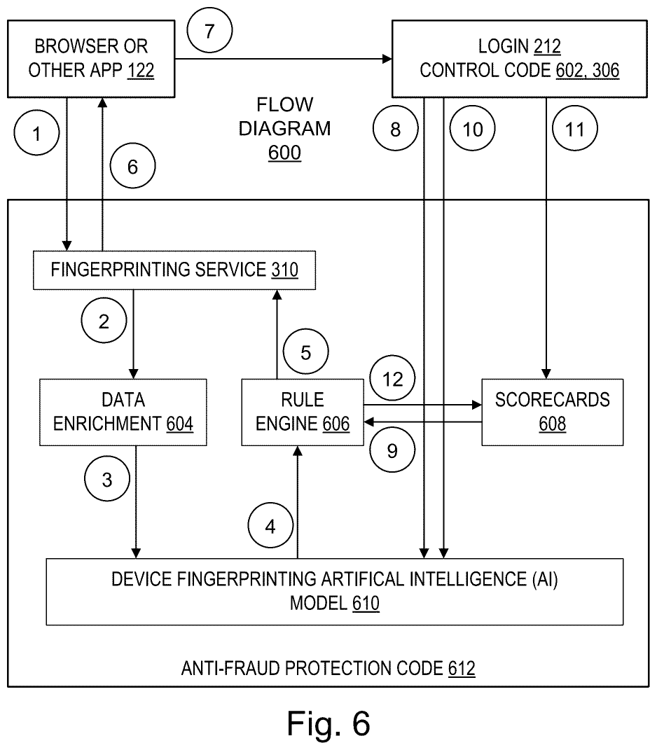

FIG. 6 is a dataflow diagram 600 of another example family of enhanced systems 202 which are each configured with CIDFP functionality 204. FIG. 6 items are discussed at various points in this disclosure.

In one example according to FIG. 6, step 1 transmits a device fingerprint data collection call, and does so 816 in real-time or near real-time, e.g., within 50 milliseconds of presentation of the login form (or in some variations within two hundred milliseconds of the presentation 812). Step 4 transmits an AI model generated risk score to a rule engine 606 from a model 610, which is also referred to as a bot model score, account creation model score, or account login model score. In some embodiments, model 610 includes a machine learning model, and in some model 610 includes an ensemble of models. Step 6 transmits DFP 612 score(s), login decision, and optionally data enrichment 604 such as telemetry or metadata or historic data. Step 7 transmits DFP 612 score(s) and the login decision to a login control code 602, e.g., code that transfers control to a refusal page or to an account home page, according to the decision. Steps 8 and 10 transmit an account status and an account label, respectively. Step 9 transmits rules updates to scorecard data structures 608. Step 11 transmits key performance indicator (KPI) review or analysis data. An app 122, login control code 602, an anti-fraud protection code 612, or portions thereof, are configured in some embodiments to operate individually or in combination as an identification module 312 or an authentication module 230.

FIGS. 1-6 do not individually or collectively or in any subset fully define a comprehensive summary of all aspects of enhanced systems 202 or all aspects of CIDFP functionality 204. Nor is any figure of FIGS. 1-6 or any group of figures of FIGS. 1-6 by itself a comprehensive summary of all aspects of an environment 100 or another context of an enhanced system 202.

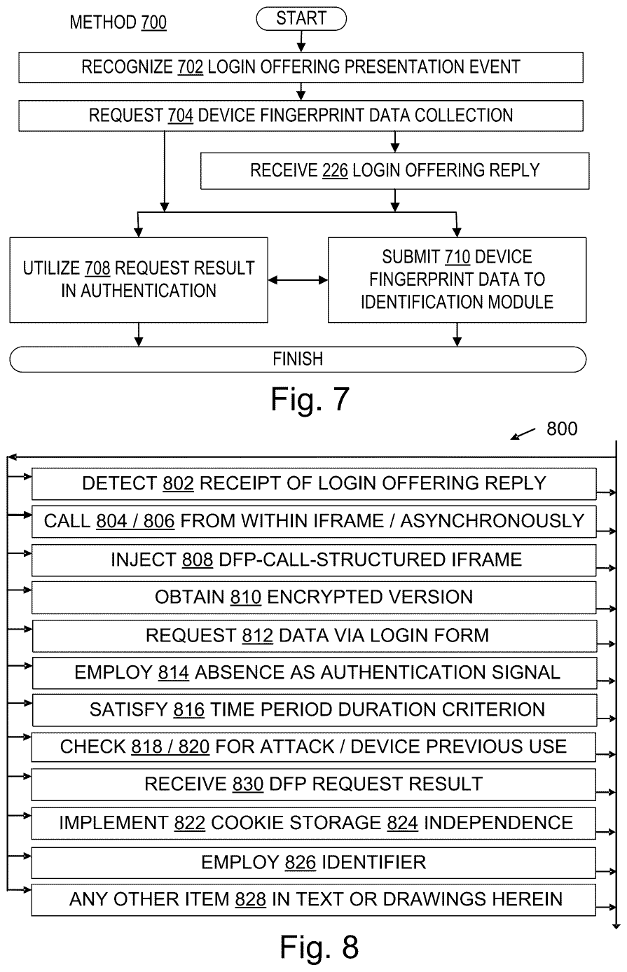

The other figures are also relevant to systems 202. FIGS. 7 and 8 are flowcharts which illustrate some methods of CIDFP functionality 204 operation in some systems 202.

In some embodiments, the enhanced system 202 is networked through an interface 136. In some, an interface 136 includes hardware such as network interface cards, software such as network stacks, APIs, or sockets, combination items such as network connections, or a combination thereof.

Some embodiments include a computing system 202 which is equipped, structured, or otherwise configured to utilize or provide CIDFP functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101, but “memory” without set also includes systems with multiple memories. Similarly, the phrase “processor set” is used to emphasize that a processor 110 is not necessarily confined to a single chip or a single machine 101, but “processor” without set also includes systems with multiple processors.

All sets herein are potentially empty unless described otherwise. Any set identified in this description may be empty, or non-empty, depending on the embodiment and circumstances. However, even an empty set is defined and detectable in the system 202 as a set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 configured for device fingerprint data collection during an interactive login 212 sequence 542, the computing system including: a digital memory 112; a processor 110 in operable communication with the digital memory; a user interface 130 residing in the digital memory; and a set of instructions 214 which is not empty, the set of instructions representing a sequence of device identification 540 steps, which upon execution by the processor: recognize 702 a presentation event 216 in the computing system (e.g., via an event handler, polling, interrupt, subscription, etc.), the presentation event 216 representing a current, prior, or upcoming presentation 812 of an interactive login offering 134 in a user interface 130, in some embodiments in response to the recognizing 702, request 704 (e.g., via an API) a collection 210 of device fingerprint data 208 of a portion of the computing system, the requesting 704 completed prior to a receipt 226 via the user interface of a reply 224 to the interactive login offering (e.g., username 536, password 510, session selection 504, etc.), and either utilize 708 at least a result 222 of the requesting (e.g., device identifier 540 set 544) during a user authentication operation 228 (e.g., login request processing), or submit 710 (e.g., via an API) a collected set 520 of device fingerprint data 208 to a user authentication module 548, or both 708 and 710. In some variations, the client requests 704 collection and then presents 812 the interactive login offering 134 in the user interface 130 shortly afterward, e.g., within 100 milliseconds.

In some embodiments, the computing system 202 is configured to obtain 810 an encrypted version 532 of the collected set 520 of device fingerprint data 208 and to submit 710 the encrypted version to a device identification module 546.

In some embodiments, the interactive login offering 134 includes a login form 502 which upon presentation 812 requests at least a username 536.

In some embodiments, the interactive login offering 134 includes a login form 502 which upon presentation 812 requests at least one of: a password 510; a biometric credential 512 (e.g., digitization of human fingerprint, or facial recognition result); a selection 504 from a set 506 of multiple active sessions 508; a digital certificate 514; or a hardware security key 516.

In some embodiments, the result 222 of the requesting represents an absence 234 of collected device fingerprint data 208, and the computing system is configured to employ 814 the absence of collected device fingerprint data as a signal 550 (e.g., a factor, a weight, a flag, or a model input) during user authentication 228.

In some embodiments, the computing system 202 is configured to employ 826 a session identifier 518 to track a login session 508 which corresponds to the interactive login offering 134, and the computing system is also configured to employ 826 a device fingerprint data collection identifier 522 which corresponds to an encrypted version 532 of the collected set 520 of device fingerprint data 208. Globally unique identifiers (GUIDs) are one example of suitable identifiers 518, 522.

In some embodiments, during an execution of the device identification steps by the computing system, an advance processing time period 524 starts when the computing system requests 704 the collection of device fingerprint data 208 and ends upon the receipt 226 via the user interface of the reply 224 to the interactive login offering 134. In some, the advance processing time period 524 is 816 at least two hundred milliseconds, and in some it is 816 at least four hundred milliseconds.

In some embodiments, the computing system is configured to utilize 708 at least the result 22 of the requesting 704 during at least one of the following user authentication operations 228: a computational check 818 for a replay attack; or a computational check 820 whether a device has been previously used during a login to an account 552 which is specified by the reply 224 to the interactive login offering 134.

Other system embodiments are also described herein, either directly or derivable as system versions of described processes or configured media, duly informed by the extensive discussion herein of computing hardware.

Although specific CIDFP architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of CIDFP functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

### Processes (a.k.a. Methods)

Processes (which are also referred to as “methods” in the legal sense of that word) are illustrated in various ways herein, both in text and in drawing figures. FIGS. 7 and 8 each illustrate a family of methods 700 and 800 respectively, which are performed or assisted by some enhanced systems, such as some systems 202 or another functionality enhanced system as taught herein. Method family 700 is a proper subset of method family 800. Moreover, activities are identified in FIGS. 1 to 6 as explicit or implicit method steps are likewise incorporated into method 800, e.g., generating, updating, sending, or receiving a request 220, a result 222, a reply 224, an iframe 232, DFP data 208, a login form 502, and so on. Also, steps that are not expressly tied herein to a particular reference number are not thereby excluded from method 800. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types into a login form 502 or clicks on an item in a user interface 130. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 8. FIG. 8 is a supplemental portion of the textual and figure drawing examples of embodiments provided herein and the descriptions of embodiments provided herein. In the event of any alleged inconsistency, lack of clarity, or excessive breadth due to an interpretation of FIG. 8, the content of this disclosure shall prevail over that interpretation of FIG. 8.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 8 to be non-operable, the sequence S is not within the scope of any claim. Any assertion otherwise is contrary to the present disclosure.

Some embodiments provide or utilize a method 800 which is performed by a computing device 308 for device fingerprint data collection during an interactive login sequence. The computing device includes a processor 110 and a memory 112 in operable communication with the processor. The method includes the computing device: recognizing 702 (e.g., via an event handler, polling, routine return, interrupt, etc.) a presentation event 216 in the computing device, the presentation event representing a presentation 812 of an interactive login offering 134 in a user interface 130; in response to the recognizing, requesting 704 a collection of device fingerprint data 208 of the computing device, the requesting completed prior to a receipt 226 via the user interface of a reply 224 to the interactive login offering; and utilizing 708 at least a result 222 of the requesting during a user authentication operation 228, or submitting 710 a collected set 520 of device fingerprint data which is not empty to a device identification module 546, or both. In some embodiments the requesting 704 is not in response to the recognizing 702 but is still completed prior to receipt 226 of the reply 224.

In some embodiments, the result 222 of the requesting 704 includes the collected set 520 of device fingerprint data 208, and the result 222 of the requesting arrives 830 at the computing device from a location 530 outside the computing device prior to the receipt 226 via the user interface 130 of the reply 224 to the interactive login offering 134.

In some embodiments, the result 222 of the requesting 704 includes the collected set 520 of device fingerprint data 208, and the result 222 of the requesting is present on the computing device prior to the receipt 226 via the user interface of the reply 224 to the interactive login offering.

In some embodiments, the method includes: detecting 802 (e.g., via an event handler, polling, interrupt, routine return, etc.) the receipt 226 via the user interface of the reply 224 to the interactive login offering 134; and in response to the detecting 802, submitting 710 a version of the collected set 520 of device fingerprint data 208 to the device identification module 312.

In some embodiments, requesting 704 the collection of device fingerprint data 208 includes calling 804 (e.g., via an API) a device fingerprint data collection service 310 from within an iframe 232 on the computing device.

In some embodiments, requesting 704 the collection of device fingerprint data 208 includes asynchronously calling 806 (e.g., via an API) a device fingerprint data collection service 310 from the computing device.

In some embodiments, the reply 224 to the interactive login offering 134 represents an absence 234 of any user account 552 identification (e.g., username 536, session ID 518, cookie 526, etc.) after a login sequence escape (e.g., login cancelled, login form 502 not fully populated, login timed out, etc.), and the method 800 includes submitting 710 the collected set 520 of device fingerprint data 208 to a user authentication module 230 in the absence of any user account identification.

### Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing CIDFP functionality 204 as disclosed herein. The Figures thus help illustrate configured storage media embodiments and process (a.k.a. method) embodiments, as well as system and process embodiments. In particular, any of the method steps illustrated in FIG. 7 or 8, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a method 800 for device fingerprint data collection during an interactive login sequence. This method 800 includes: recognizing 702 a presentation event 216 in a computing device, the presentation event representing a presentation 812 of an interactive login offering 134 in a user interface 130; in response to the recognizing (or in some variations within three hundred milliseconds of the recognizing, up to three hundred milliseconds before or up to three hundred milliseconds after the recognizing), requesting 704 a collection of device fingerprint data 208 of the computing device, the requesting completed at least one hundred milliseconds prior 816 to a receipt 226 via the user interface of a reply 224 to the interactive login offering; and utilizing 708 (e.g., as a calculation basis) at least a result 222 of the requesting during a user authentication operation 228, or submitting 710 (e.g., via an API) a collected set 520 of device fingerprint data to a user authentication module 230, or both.

In some embodiments, the method 800 includes: injecting 808 an iframe 232 into the user interface 130, the iframe configured by code to perform a requesting 704 of a collection of device fingerprint data 208; recognizing 702 a presentation event 216 in a computing device, the presentation event representing a presentation 812 of an interactive login offering 134 in a user interface 130; performing by the iframe code the requesting 704 of the collection of device fingerprint data of the computing device; and utilizing 708 at least a result 222 of the requesting during a user authentication operation 228, or submitting 710 a collected set 520 of device fingerprint data to a user authentication module 230, or both.

In some embodiments, the method includes computationally implementing 822 a cookie independence characteristic 528 by computationally storing 824 the collected set of device fingerprint data 208 only in one or more locations 530 in the system 202 which are external to any browser cookie 526. In other embodiments, device fingerprint data 208 is stored 824 in a cookie 526.

In some embodiments, the method includes computationally injecting 808 an iframe 232 into the user interface 130, the iframe configured (e.g., by a script with code to make a call 806) to perform the requesting 704 the collection of device fingerprint data 208.

In some embodiments, an iframe injected in the UX 306 calls a DFP profiling service 310 to initiate the device fingerprinting. The profiling service 310 calls a DFP assessment API 610 with the fingerprints to get a verdict that will be returned to the UX. The client UX initiates 206 the DFP fingerprinting call as soon as the necessary information is obtained from the server. The response from DFP 612 is received by the UX and posted to the login endpoint.

In some embodiments, the requesting 704 begins within three hundred milliseconds of the recognizing, and the requesting 704 is completed at least one hundred milliseconds prior 816 to a receipt 226 via the user interface of a reply 224 to the interactive login offering.

In some embodiments, the requesting 704 is completed (e.g., control has been returned from a requesting 704 routine invocation) at least five hundred milliseconds prior 816 to a receipt 226 via the user interface of a reply 224 to the interactive login offering.

In some embodiments, recognizing 702 the presentation event 216 includes recognizing 702 a page load event 534, e.g., loading of a login page.

### Additional Observations

Support for the discussion of CIDFP functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

Some embodiments utilize or provide methods 800 or enhanced systems 202 to improve cybersecurity. Cybersecurity platforms use device fingerprinting to help them detect and respond to potential threats and intrusions. However, teachings herein, such as tools and techniques for providing an advance processing period 524 as additional time to collect device fingerprint data 208, are also applicable for other fields such as targeted advertising, web analytics, and network management, instead of or in addition to uses that enhance security.

Device fingerprinting in general collects and analyzes a device's characteristics to identify and track a user or a user device, or both. Device fingerprinting is used for various purposes. Device fingerprinting helps businesses prevent fraud and ensure the security of their online platforms, because it helps identify suspicious activity such as a hijacked banking session or a fraudulent order. Advertisers use device fingerprinting to track users across websites and to create user profiles that support targeted advertising. Device fingerprinting is sometimes used to validate a user's identity. Sometimes device fingerprinting is a factor in determining a level of risk for a login or an online transaction. Device fingerprinting helps website owners identify returning visitors to a website. Device fingerprinting helps with network management by helping to identify rogue devices, troubleshoot performance issues, and detect network vulnerabilities.

Depending on the implementation, device fingerprinting collects various identifiers from a device or about a device for use as device fingerprint data, such as one or more of: a browser version, an IP address, an operating system or other kernel version, a screen resolution, a list of system fonts, one or more HTTP cookies, an embedded hardware device ID, a global positioning system value or other location data, or service set identifiers of one or more Wi-Fi networks. These are examples; this is not a comprehensive list of all possible device fingerprint data 208.

In some embodiments, a method 800 includes presentation of an interactive login offering 134, which includes for example asking for a username, asking for an active session choice, etc.

For example, in some embodiments a Login Username View presents a login form with content such as “Sign in” and a box or a blank line to receive a username, and a Next button. Some include “No account? Create one!” with a link to an account creation page. Some include “Can't access your account?” with a link to a password recovery or username recovery page. Some include “Sign in options” with a link to a page listing other sign in options, e.g., to sign in based on a biometric credential or a hardware security key. This Login Username View login form 502 is useful, e.g., in a scenario where a user enters a tenanted endpoint and has logged in before. At this stage in some embodiments, the username or other account identifier is cached so that if the same user logs in later the system can immediately invoke a DFP service 310 fingerprinting script.

In some embodiments, a First Factor View presents a login form with content such as a previously entered email address or other username, “Enter password” and a box or a blank line to receive a password (or a passphrase - “password” herein encompasses pass phrases), and a Sign in button. Some include “Forgot my password” with a link to a password recovery page. Some include an option to sign in with a biometric credential (e.g., via facial recognition) or a hardware security key. At this stage, some embodiments retrieve cached data for the user, to get a DFP service 310 URL and start running a fingerprinting script.

In some embodiments, a call to get a DFP service 310 URL is, or resembles, a GCT call. GCT refers to Get Credential Type, which is an API that indicates which kind of first factor the login is using.

In some embodiments an Account Picker View presents a login form with content such as “Pick an account” and a list of accounts associated with a given username or a given device hardware ID. Some include “Use another account” as an option. This scenario involves having two or more active sessions that the user can log into. Upon clicking to select a session, the user is automatically signed in, e.g., via a browser single sign on capability.

In some embodiments a Security Key View presents a login form with content such as “Sign in with a security key” or “Sign in with Facial Recognition or a security key”. Some include a Back button. In this scenario a user enters a username which invokes a call for cached data related to a username, e.g., internal and display versions of the username, whether the username/account is a managed account, which kinds of credentials are associated with the username/account, and so on. In some cases, this call provides the DFP service 310 URL but also indicates that a preferred authentication procedure uses a hardware security key compliant with a Fast Identity Online (FIDO®) standard (mark of FIDO Alliance), so the system presents a corresponding Login FIDO view and invokes WebAuthN web authentication. This involves a redirection, e.g., to the login dot contoso dot com domain. This view however is still part of the parent Login page so after successful or failed response the user is redirected to login. An IFrame event listener in the parent login page subscribes to the reply and this is forwarded to the login endpoint. Some embodiments send the DFP service 310 URL from contosoonline to a contoso domain, through a POST/query string operation.

In some embodiments a Certificate Based Authentication View presents a login form with content such as “Sign in with your certificate”. Some include a Back button. In some embodiments, this is similar to Security Key Based Authentication, and does a redirect to a certificate domain for authentication. This redirect happens after an interstitial screen, in which the system listens to the offering 134 reply 224.

In some embodiments, before the reply 224 to the presentation is received, and in response to the interactive login offering presentation, a request 220 is made 704 to collect DFP data 208. The presentation reply could be or include, e.g., a username 536, a password 510, a selection 504 of an active session 508, biometric data 512 such as face recognition data or human fingerprint data, a hardware security key 516, or a digital certificate 514. Finally, the result of the collection request is used. If no DFP data 208 was collected, that is used in some embodiments as an anomaly signal 550. If collected DFP data 208, 520 arrives, it is either utilized for authentication or submitted to an authentication module for use, or both, in some embodiments.

In some embodiments, use of cookies is optional for client-side DFP service 310 integration. When cookies are supported by the web browser, they are used to optimize the performance and accuracy of device fingerprinting.

In some embodiments, a unique id is employed to track a specific request or session. Some embodiments also have a unique id to add to the encrypted token to discourage, prevent, or detect tampering with the token. In some cases, one or both identifiers is a GUID, but other identifiers are also employed in some embodiments.

In some embodiments, token data are separate from the login credentials, and in others they are bundled together.

Some embodiments send the DFP data 208, 520 even though the user escaped out of the login, e.g., did not provide any username, or closed the window containing the login form. In some scenarios, an embodiment collects fingerprints for devices that are testing usernames to see if they exist. Even if the sign in doesn't complete or it is canceled, the embodiment records the fingerprint and maintains a list of fingerprints that are suspicious for attempting logins but not finishing them. The list is employed either to block that device from signing in or marking sign ins from that device as risky. This list is also or instead used in some embodiments as a test case for development involving UX 304 changes, to see if changes improve sign in success rate for users/devices that are familiar vs. unfamiliar.

In some embodiments, DFP 612 operations provide a device identifier that changes when an actor plays a token from a new device (e.g., via a sign-in page onboarded to DFP 612). This device identifier is hard to replicate and is not carried in the token, so it can be leveraged to make token theft detection more robust. Moreover, man-in-the-middle attempts do not generate a DFP fingerprint 520 at all. This is because the spoofed sign-in page does not execute the DFP service 310 code to generate the fingerprint. Some embodiments leverage the lack of a DFP sign-in 520 as an indicator of a potential attack when DFP service 310 is onboarded to all interactive sign-in endpoints.

Some embodiments integrate detections from dynamics fraud protection code (DFP code 612) to improve user risk calculations in services that help organizations manage and secure identities in multicloud and hybrid environments, or identity provider services, for example. Note that DFP is also an acronym for device fingerprinting 310. In the present context, DFP 612 is a cloud-based service that provides fraud detection and prevention capabilities for online transactions. DFP 612 uses machine learning and behavioral analytics to assess the risk level of each transaction and provide recommendations for acceptance, rejection, or review. DFP 612 also provides insights and reports on fraud patterns and trends, and tools to configure fraud policies and rules.

### Machine Learning Models, Including Language Models

Some examples of models include large language models (LLMs), small language models (SLMs), large action models (LAMs), small action models (SAMs), multimodal language models, multimodal action models, and foundation models (a term which has multiple meanings in the industry that do, however, overlap the definitions herein). A language model is trained on tokens representing at least natural language or programming language, whereas an action model is trained on tokens representing at physical least actions, e.g., robotic movements, human or animal movements, workpiece movements, real-world object manipulation, or simulations thereof. Some action models can learn from observation and demonstration of user physical actions. A multimodal model accepts as input, or produces as output, or both, multiple modes of data, e.g., data representing written language, still images, video (e.g., photographed or animated or mixed) clips, audio (including direct voice input in some, and audio clip input or output), music, sensor telemetry, augmented reality, or other modes. Some multimodal models encode different modes separately, while others encode multiple modes of input data together, e.g., vision and text. Some merge modes, some utilize cross attention across modes.

Many models, but not all, utilize a transformer architecture internally, e.g., in decoders or in paired encoder-decoder architectures. One exception is a Vision-Mamba model, a vision tasks model that utilizes an alternate internal architecture of repeated Mamba blocks interleaved with standard normalization layers and residual connections.

Some models utilize multi-token prediction internally, e.g., through an architecture having a shared model trunk with multiple independent output heads, and training to predict multiple future tokens at once using, e.g., self-speculation. Multi-token prediction can provide improved sample efficiency and faster inference than single-token prediction, giving significant gains in generative benchmarks, e.g., for source code generation tasks.

In some embodiments a model employs chain-of-thought reasoning, a technique which prompts the model to output a sequence of intermediate steps to accomplish a task. In some scenarios, this technique improves the model's reasoning abilities by allowing the model to focus on solving one subtask at a time rather than the entire task problem all at once. This technique sometimes allows the model to solve problems that are otherwise not feasible for that model, and also enhances the interpretability of the model's output by showing how the model arrived at the problem solution.

Model context size limits vary, from early model limits of 4K tokens to the present size of at least 128K in many models, and even greater sizes in some at a cost of reduce attention

A language model, action model, or other machine learning model within or utilized by an enhanced system 202 is not necessarily a large language model (LLM) or a large action model (LAM) in every embodiment, but it is an LLM or an LAM in some embodiments. For present purposes, a language model or an action model is “large” if it has at least a billion parameters. For example, GPT-2 (OpenAI), MegatronLM (NVIDIA), T5 (Google), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry.

Some additional examples of models one of skill will consider suitable for a given embodiment include GPT4o (OpenAI), Gemini Pro 1.5 (Google), Gemma (Google), Claude (Anthropic), Command (Cohere), Falcon 180B (Technology Innovation Institute), DBRX (Databricks and Mosaic), and Mistral variants (Mistral). Actual inclusion or use by an embodiment depends on technical factors such as the computing requirements of the intended deployment device relative to the desired model performance, and whether multimodality is required.

Model stability is a consideration in some embodiments and some scenarios. Instability leads to inconsistency in model responses to prompts. Model stability is sometimes dependent on model parameters. Some different models have different stability parameters, and some exhibit different variability between answers to the same question even while using the same stability parameters. Some models are stabilized by adjusting parameters such as temperature, frequency penalty, presence penalty, or nucleus sampling, and also or instead by constraining the queries sent to a given instance of the model.

Small models often provide more deployment flexibility, being able to run on edge devices such as user devices when a large model would require greater computing power or memory or both than is available on the edge device, at least for acceptable performance. One measure of acceptable performance in some embodiments is to provide human interaction with acceptable performance, e.g., user interface responses in under 5 seconds for most prompts other than clip generation prompts. However, small models typically have less recall than large models, making them more suitable for narrower fields of use than large models which can perform well with a larger range of tasks.

In some scenarios, model performance is optimized by use of suitable training data, fine-tuning, prompt engineering, or a combination thereof. In some scenarios part or all of the training data is synthesized data. Some tools, for example, focus automated pipelines to create high-quality synthesized data for training models for specialization and model self-improvement. More generally, training is accomplished using supervised learning or semi-supervised learning, to the extent labeled data is available and effective, but some scenarios rely at least in part on unsupervised learning.

Model performance is enhanced in some embodiments by retrieval augmented generation, by filtering inputs or outputs or both for toxic or off-topic material, and/or by other quality control mechanisms.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Note Regarding Hyperlinks

Portions of this disclosure contain URIs, hyperlinks, IP addresses, and/or other items which might be considered browser-executable codes. These items are included in the disclosure for their own sake to help describe some embodiments, rather than being included to reference the contents of the web sites or files that they identify. Applicant does not intend to have these URIs, hyperlinks, IP addresses, or other such codes be active links. None of these items are intended to serve as an incorporation by reference of material that is located outside this disclosure document. Thus, there should be no objection to the inclusion of these items herein. To the extent these items are not already disabled, it is presumed the Patent Office will disable them (render them inactive as links) when preparing this document's text to be loaded onto its official web database. See, e.g., United States Patent and Trademark Manual of Patent Examining Procedure §608.01(VII).

### Technical Character

The technical character of embodiments described herein will be apparent to one of ordinary skill in the art, and will also be apparent in several ways to a wide range of attentive readers.

For example, some embodiments address technical activities such as recognizing 701 a login offering 134 presentation 812 without employing human senses or human actions, requesting 704 device fingerprint data 208 collection without employing human senses or human actions, and utilizing 708 fingerprint data 208 for authentication 228 without employing human senses or human actions, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., user interface 130 login forms 502, device fingerprinting data collection services 310, identification modules 312 (e.g., identity provider modules), authentication modules 230 (e.g., models 610, login control code 602), security token services 402, sessions 508, and accounts 552. None of these are mental concepts or present merely on paper.

In addition, some of the technical effects discussed include, e.g., providing additional time 524 to collect fingerprint data 208, improved security, improved authentication speed, and improved scalability. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that user authentication, device fingerprinting, and other computational activities described herein are each a technical activity which cannot be performed mentally at all, because the mechanisms in question lack I/O devices that would allow a human to somehow “read” or “write” values within the computing system as described. People do not manually call a device fingerprinting service while typing a username or a password. Hence, computing technology operational improvements such as the various examples of CIDFP functionality 204 described herein are improvements to computing technology. People manifestly lack the speed and the digital communication and computation capabilities which are required to perform CIDFP as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as an identity securing service, an identity provider service, an account consumer identity service, or tools for cloud-based identity management and access management. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed relevant to a particular embodiment. However, it does not follow from the availability of a broad context that exclusive rights are being sought herein for abstract ideas; they are not. In particular, no claim is made to user authentication activities generally, or device fingerprinting activities generally, as opposed to the particular CIDFP methods, systems, and devices described and claimed in the eventual final claims based on the present disclosure.

Rather, the present disclosure is focused on providing appropriately specific embodiments whose technical effects fully or partially solve particular technical problems, such as how to obtain device identifications faster so they can be acted on sooner in a computing system, and how to map devices to user accounts for tracking or security or other purposes. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
AJAX: Asynchronous JavaScript® And XML (mark of Oracle America, Inc.).
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network
XML: eXtended Markup Language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human actions per se. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Linux® ps or similar utilities in other operating system environments (mark of Linus Torvalds). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. User authentication operations such as calling a DFP collection service 310, employing 814 absence as a signal 550, injecting 808 an iframe 232 into user experience code 306, and many other operations discussed herein (whether recited expressly in the Figures or not), are understood to be inherently non-human. A human mind cannot interface directly with a computing device to perform the CIDFP steps 800 taught herein. This would all be well understood by persons of skill in the art in view of the present disclosure. Moreover, one of skill understands that CIDFP functionality 204 cannot be implemented merely with conventional tools and steps, because actual implementation requires the use of teachings which were first provided in the present disclosure, e.g., CIDFP teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical or prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, such as authenticating, calling, checking, collecting, detecting, employing, gathering, identifying, implementing, injecting, loading, obtaining, presenting, reading, receiving, recognizing, requesting, satisfying, sending, storing, submitting, utilizing, writing (and authenticates, authenticated, calls, called, etc.) with regard to a destination or other subject may involve intervening action, such as the foregoing or any action recited in this disclosure or inherent in a step recited in this disclosure, yet still be understood as being performed directly by or on behalf of the party of interest. Example verbs listed here may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, all of the recognizing and all of the requesting described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A relevant distinction in this example is that a computing system 102 contains one or more machines 101, whereas reference numeral 101 refers to a single machine, e.g., a single laptop, a single smartphone, a single workstation, a single Internet of Things device, etc. Similarly, particular kinds of data are referred to on occasion with two reference numbers, one of which is 118 indicating data generally, and the other of which refers to a particular category of data, e.g., login reply 224 values, or another data category, depending on the functionality being described. However, reference numerals for more general categories are often omitted herein for better readability, particularly when one of skill would acknowledge that the more general category encompasses a more specific category whose reference numeral is recited.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, CIDFP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
130 user interface hardware and software
132 interactive; refers to interaction between a computing system and a human, from the point of view of the computing system and computing system activity
134 login offering, e.g., a login form 502 presented in a user interface
136 interface generally, e.g., network interface card, API, user interface, or other mechanism by or through which separable items communicate in a computing system, where examples of separable include physically separable, separately compilable, separately installable, or separably replaceable without loss of functionality
202 enhanced system, i.e., system 102 enhanced with functionality 204 as taught herein
204 client-initiated device fingerprint collecting functionality (also referred to as functionality 204, or CIDFP functionality), e.g., a mechanism which performs or is configured to perform steps 702 and 704 prior to step 226, or any mechanism which performs or is configured to perform a sequence of user authentication activities or device fingerprint collection activities or both, first disclosed herein, or to perform a novel method 800 first disclosed herein
218 event generally, as represented in a computing system
234 absence, as represented in a computing system, e.g., by a null pointer, a counter value of zero, an identification of a non-existent account, a data structure representing an empty list or an empty set, or another digital value or data structure in the computing system
700 flowchart; 700 also refers to CIDFP methods that are illustrated by or consistent with the FIG. 7 flowchart or any variation of the FIG. 7 flowchart described herein
800 flowchart; 800 also refers to CIDFP methods that are illustrated by or consistent with the FIG. 8 flowchart, which incorporates the flowchart of FIG. 7, the steps implicit or express in FIGS. 1 through 6, and all other steps taught herein, or methods that are illustrated by or consistent with any variation of the FIG. 8 flowchart described herein; all CIDFP method steps are computational or otherwise artificial, not human activity
828 any step or item discussed in the present disclosure that has not been assigned some other reference numeral; 828 may thus be shown expressly as a reference numeral for various steps or items or both, and may be added as a reference numeral (in the current disclosure or any subsequent patent application which claims priority to the current disclosure) for various steps or items or both without thereby adding new matter

### Conclusion

In some embodiments, a client 302 on a computing device 308, 101 presents 812 a login form 502 seeking a username 536, a password 510, or other login data 504, 512, 514, 516. At or near the same time (i.e., at the same time or less than 100 milliseconds before, or less than 100 milliseconds after) 816 that the login form is presented, and before the client receives 226 a reply 224 to the login form (e.g., login data or an indication the login sequence is terminated), the client requests 704 collection 210 (verb or noun) of fingerprint data 208 of the device. The collection request's timing provides more time 524 to collect fingerprint data than an alternative approach where a server requests fingerprint data only after receiving the login data. In some cases, the fingerprint data collection request 220 is asynchronous 806. In some cases, an absence 234 of fingerprint data 208 during authentication 228 indicates 814 an anomaly, e.g., a possible man-in-the-middle attack. In some cases, the fingerprint data collection request 220 is made 804 from an iframe 232 that was injected 808 into a client's user interface 130. In some cases, the fingerprint data 208, 520 is collected despite cancellation of the login sequence, e.g., by user action or by timeout.

Embodiments are understood to also themselves include or benefit from tested and appropriate security controls and privacy controls such as the General Data Protection Regulation (GDPR). Use of the tools and techniques taught herein can be used together with such controls.

Although particular vendor technology is used in some motivating examples, the teachings herein are not limited to use in technology supplied or administered by any particular vendor. Under a suitable license, for example, the present teachings could be embodied in hardware provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method performed by a computing device for device fingerprint data collection during an interactive login sequence, the computing device comprising a processor and a memory in operable communication with the processor, the method comprising the computing device:
recognizing a presentation event in the computing device, the presentation event representing a presentation of an interactive login offering in a user interface;
in response to the recognizing, requesting a collection of device fingerprint data of the computing device, the requesting completed prior to a receipt via the user interface of a reply to the interactive login offering; and
submitting a collected set of device fingerprint data which is not empty to a device identification module, or both.

2. The method of claim 1, wherein the result of the requesting comprises the collected set of device fingerprint data, and the result of the requesting arrives at the computing device from a location outside the computing device prior to the receipt via the user interface of the reply to the interactive login offering.

3. The method of claim 1, wherein the result of the requesting comprises the collected set of device fingerprint data, and the result of the requesting is present on the computing device prior to the receipt via the user interface of the reply to the interactive login offering.

4. The method of claim 1, comprising:
detecting the receipt via the user interface of the reply to the interactive login offering; and
in response to the detecting, submitting a version of the collected set of device fingerprint data to the device identification module.

5. The method of claim 1, wherein requesting the collection of device fingerprint data comprises calling a device fingerprint data collection service from within an iframe on the computing device.

6. The method of claim 1, wherein requesting the collection of device fingerprint data comprises asynchronously calling a device fingerprint data collection service from the computing device.

7. The method of claim 1, wherein the reply to the interactive login offering represents an absence of any user account identification after a login sequence escape, and the method comprises submitting the collected set of device fingerprint data to a user authentication module in the absence of any user account identification.

8. A computing system configured for device fingerprint data collection during an interactive login sequence, the computing system comprising:
a digital memory;
a processor in operable communication with the digital memory;
a user interface residing in the digital memory; and
a set of instructions which is not empty, the set of instructions representing a sequence of device identification steps, which upon execution by the processor: recognize a presentation event in the computing system, the presentation event representing a presentation of an interactive login offering in a user interface, request a collection of device fingerprint data of a portion of the computing system, the requesting completed prior to a receipt via the user interface of a reply to the interactive login offering, and utilize at least a result of the requesting during a user authentication operation or submit a collected set of device fingerprint data to a user authentication module, or both.

9. The computing system of claim 8, wherein the computing system is configured to obtain an encrypted version of the collected set of device fingerprint data and to submit the encrypted version to a device identification module.

10. The computing system of claim 8, wherein the interactive login offering comprises a login form which upon presentation requests at least a username.

11. The computing system of claim 8, wherein the interactive login offering comprises a login form which upon presentation requests at least one of:
a password;
a biometric credential;
a selection from a set of multiple active sessions;
a digital certificate; or
a hardware security key.

12. The computing system of claim 8, wherein the result of the requesting represents an absence of collected device fingerprint data, and the computing system is configured to employ the absence of collected device fingerprint data as a signal during user authentication.

13. The computing system of claim 8, wherein the computing system is configured to employ a session identifier to track a login session which corresponds to the interactive login offering, and the computing system is also configured to employ a device fingerprint data collection identifier which corresponds to an encrypted version of the collected set of device fingerprint data.

14. The computing system of claim 8, wherein, during an execution of the device identification steps by the computing system, an advance processing time period starts when the computing system requests the collection of device fingerprint data and ends upon the receipt via the user interface of the reply to the interactive login offering, and the advance processing time period is at least two hundred milliseconds.

15. The computing system of claim 8, wherein the computing system is configured to utilize at least the result of the requesting during at least one of the following user authentication operations:
a check for a replay attack; or
a check whether a device has been previously used during a login to an account which is specified by the reply to the interactive login offering.

16. A computer-readable storage medium configured with data and instructions which upon execution by a processor of a computing system perform a method for device fingerprint data collection during an interactive login sequence, the method comprising:
injecting an iframe into the user interface, the iframe configured by code to perform a requesting of a collection of device fingerprint data;
recognizing a presentation event in a computing device, the presentation event representing a presentation of an interactive login offering in a user interface;
performing by the iframe code the requesting of the collection of device fingerprint data of the computing device; and
utilizing at least a result of the requesting during a user authentication operation, or submitting a collected set of device fingerprint data to a user authentication module, or both.

17. The computer-readable storage medium of claim 16, wherein the method further comprises implementing a cookie independence characteristic by storing the collected set of device fingerprint data only in one or more locations which are external to any browser cookie.

18. The computer-readable storage medium of claim 16, wherein the requesting begins within three hundred milliseconds of the recognizing, and the requesting is completed at least one hundred milliseconds prior to a receipt via the user interface of a reply to the interactive login offering.

19. The computer-readable storage medium of claim 16, wherein the requesting is completed at least five hundred milliseconds prior to a receipt via the user interface of a reply to the interactive login offering.

20. The computer-readable storage medium of claim 16, wherein recognizing the presentation event comprises recognizing a page load event.
